(19) United States
(12) Patent Application Publication
(10) Pub. No.: US 2026/0266651 A1
(43) Pub. Date: Sep. 10, 2026

(54) PRODUCT HANDLING APPARATUS

(71) Applicant: ISHIDA CO., LTD., Kyoto (JP)

(72) Inventor: Wataru ITO, Kyoto (JP)

(73) Assignee: ISHIDA CO., LTD., Kyoto (JP)

(21) Appl. No.: 19/556,806

(22) Filed: Mar. 4, 2026

(30) Foreign Application Priority Data
Mar. 6, 2025 (JP) 2025-035264

(51) Int. Cl. G01G 23/42

(52) U.S. Cl. CPC G01G 23/42

(57) ABSTRACT

A product handling apparatus is configured to calculate nutrient amounts of a product based on nutrient amounts per unit mass of the product and a mass of the product in a weighed amount, and print, on a print medium, the calculated nutrient amounts as nutrient amounts of the product. The product handling apparatus includes a storage section that stores nutrient amounts for a person to consume per day as reference intakes, depending on differences in physical characteristics of the person, an acquisition section that acquires the physical characteristics of the person who purchases the product, and a controller that acquires, from the storage section, the reference intakes relative to the physical characteristics acquired via the acquisition section, calculates proportions of the nutrient amounts included in the product, and controls the printing section to print the calculated proportions of the nutrient amounts on the print medium.

### TECHNICAL FIELD

An aspect of the present invention relates to a product handling apparatus.

### BACKGROUND

There have been known product handling apparatuses, such as a label issuing apparatus that issues product labels to be attached to processed foods (for example, daily dishes and the like) and the like, and a label issuing-attaching apparatus that attaches issued product labels to products (for example, Japanese Unexamined Patent Publication No. 2017-047947). In response to a recent increased disclosure demand from consumers, the number of display items that are mandatory to be displayed on product labels attached to processed foods subjected to weighing (for example, daily dishes and the like), is increasing. For example, in the Food Labeling Act, it is mandatory to display nutrient amounts of general processed foods (daily dishes and bread). Specifically, it is mandatory to display “nutrition facts” on product labels of daily dishes, bread, and the like, and to display five items of calories (kcal), protein (g), fat (g), carbohydrates (g), and salt equivalent amount (g).

### SUMMARY

Furthermore, in addition to displaying nutrient amounts depending on masses of foods, a demand for displaying what percentages (%) of nutrient amounts when a food product is consumed can be consumed relative to target nutrient amounts to be consumed per day, has recently arisen. Nevertheless, target nutrient amounts for a person to be consumed per day vary depending on age, sex, physical activity level, and the like, so that it is hard to say that the request from purchasers is fulfilled only by displaying proportions with respect to adult models.

Therefore, an object of an aspect of the present invention is to provide a product handling apparatus capable of responding to a further increased disclosure demand from purchasers.
(1) A product handling apparatus according to an aspect of the present invention is a product handling apparatus that calculates nutrient amounts of a product based on nutrient amounts per unit mass of the product and a mass of the product in a weighed amount, and prints, on a print medium, the calculated nutrient amounts as nutrient amounts of the product, the product handling apparatus including a first storage section that stores nutrient amounts for a person to consume per day as reference intakes in accordance with differences in physical characteristics of the person, an acquisition section that acquires the physical characteristics of the person who purchases the product, and a controller that acquires, from the first storage section, the reference intakes corresponding to the physical characteristics acquired by the acquisition section, calculates proportions of the nutrient amounts included in the product relative to the acquired reference intakes, and controls the printing section to print the calculated proportions of the nutrient amounts on the print medium.

In the product handling apparatus with this configuration, it is possible to provide, depending on physical attributes of the purchaser, what percentages (%) of the nutrient amounts the purchaser is supposed to consume (proportions of obtained nutrient contents) by consuming the product in a weighed amount (purchased food) relative to the reference intakes that are the nutrient amounts for the purchaser to consume per day. This makes it possible to provide the proportions of the obtained nutrient contents depending on the physical attributes of the purchaser, instead of simply providing proportions of obtained nutrient contents with respect to an adult model uniformly, so that it is possible to respond to a further increased disclosure demand from consumers.
(2) In the product handling apparatus according to the above (1), the physical characteristics may be classified according to differences in age, sex and physical activity level of people, and the first storage section may store, for each of the classified physical characteristics, calories as well as masses for each of protein, fat, carbohydrates and salt equivalent that are required as the nutrient amounts to be consumed per day. With this configuration, the physical characteristics of purchasers can be easily classified into categories. This makes it also possible to provide proportions of the daily nutrient intake accounted for by the calories, the protein, the fat, the carbohydrates, and the salt equivalent for each product and for each category of the physical characteristics of purchasers.
(3) In the product handling apparatus according to the above (1) or (2), the controller may control the printing section to print, in addition to the calculated proportions of the nutrient amounts, the reference intakes serving as a basis for the calculation of the proportions of the nutrient amounts on the print medium as estimated values. With this configuration, it is possible to provide the purchaser with the reference intakes serving as the basis for the calculation of the proportions of the nutrient amounts.
(4) In the product handling apparatus according to any one of the above (1) to (3), the product handling apparatus may include a second storage section that stores, for each product, a mass per meal of the product and nutrient amounts when the product with the mass per meal is consumed, and the controller may control the printing section to print on the print medium, in addition to the calculated proportions of the nutrient amounts, a mass per meal of the product in a weighed amount and nutrient amounts when the product in a weighed amount with the mass per meal is consumed, and control the printing section to print the mass per meal of the product in a weighed amount on the print medium following characters of “per meal”. With this configuration, it is possible to provide the purchaser with the mass per meal of the product and the nutrient amounts when the product with the mass per meal is consumed.
(5) In the product handling apparatus according to the above (4), when the mass of the product in a weighed amount exceeds the mass per meal of the product stored in the second storage section, the controller may control the printing section to print characters of “per package” on the print medium, or to print, on the print medium, a value including a decimal part indicating how many meals the product in a weighed amount provides, the value being obtained by dividing the mass of the product in a weighed amount by the mass per meal of the product. With this configuration, it is possible to flexibly switch between whether to print the characters “per package” on the print medium or print the value indicating how many meals the mass per meal of the weighed product provides, even in cases where the mass of the weighed product exceeds the mass per meal of the product.
(6) In the product handling apparatus according to any one of the above (1) to (5), the controller may control the printing section to print on the print medium, in addition to the calculated proportions of the nutrient amounts, the reference intakes relevant to the physical characteristics acquired by the acquisition section. With this configuration, it is possible to provide the purchaser with the reference intakes that are the nutrient amounts for the purchaser to consume per day.

According to the aspect of the present invention, it is possible to respond to the further increased disclosure demand from purchasers.

### BRIEF DESCRIPTION OF THE DRAWINGS

FIG. 1 is a perspective view illustrating a label issuing apparatus serving as a product handling apparatus according to an embodiment;

FIG. 2 is a functional block diagram illustrating a functional configuration of the label issuing apparatus in FIG. 1;

FIG. 3A is an example of a product label issued by the label issuing apparatus in FIG. 1; FIG. 3B is another example of the product label issued by the label issuing apparatus in FIG. 1;

FIG. 4 is a table indicating each of masses of protein, fat, carbohydrates, and salt equivalent and calories that are stored in a storage section and required as nutrient amounts to be consumed per day for each category of physical characteristics;

FIG. 5 is an example of a nutrient amount registration screen displayed on a display section;

FIG. 6 is an example of a physical-demographic characteristic setting screen displayed on the display section;

FIG. 7 is an example of a product information screen displayed on the display section;

FIG. 8 is a diagram for explaining a data flow in the label issuing apparatus;

FIG. 9 is a perspective view illustrating a face-to-face scale apparatus serving as the product handling apparatus according to a modification;

FIG. 10A is an example of a product selection screen displayed on a display section; FIG. 10B is an example of a physical-demographic characteristic setting screen displayed on the display section; and

FIG. 11 is a perspective view illustrating a weighing-packaging-labeling apparatus serving as the product handling apparatus according to a modification.

### DETAILED DESCRIPTION

Hereinafter, a label issuing apparatus (product handling apparatus) 1 according to an embodiment will be described with reference to the drawings. In the description of the drawings, the same elements are denoted by the same reference signs, and redundant description will be omitted. In addition, “A or B” in the present specification may include any one of A and B, and including both A and B is not excluded.

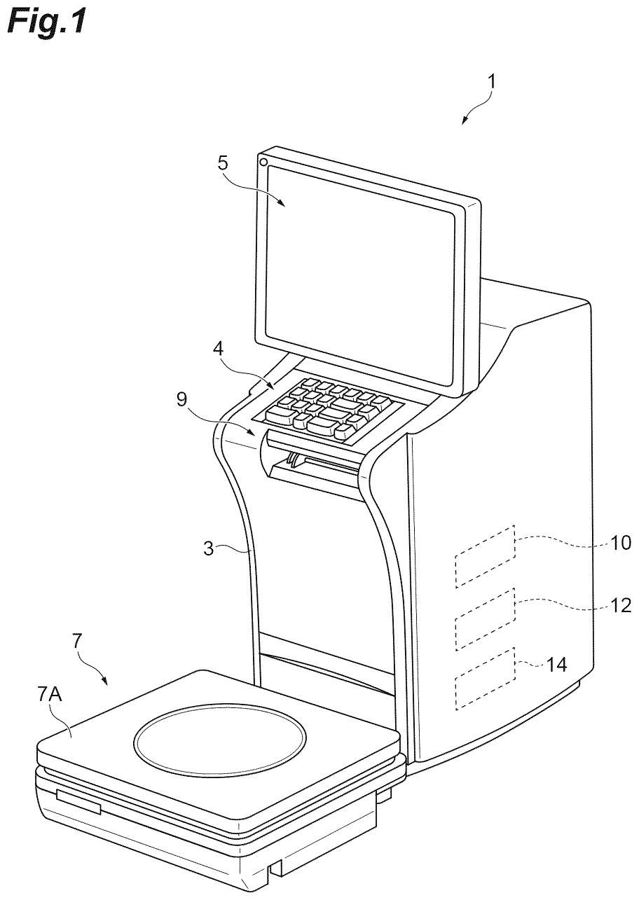

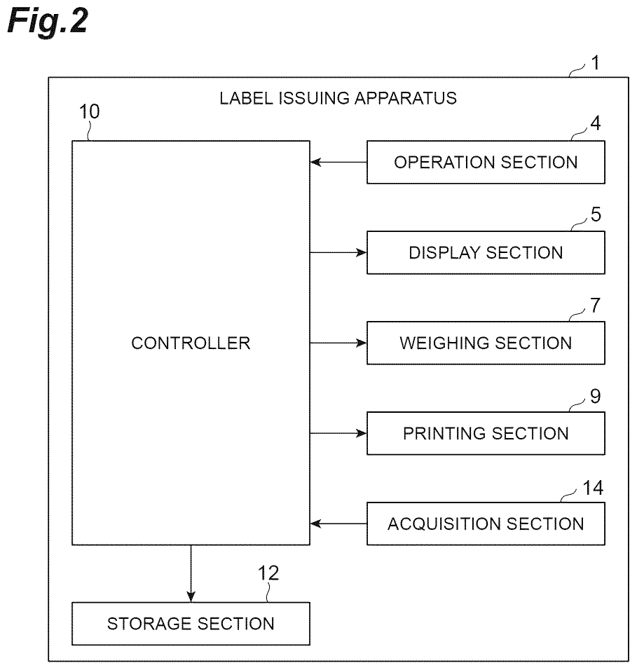

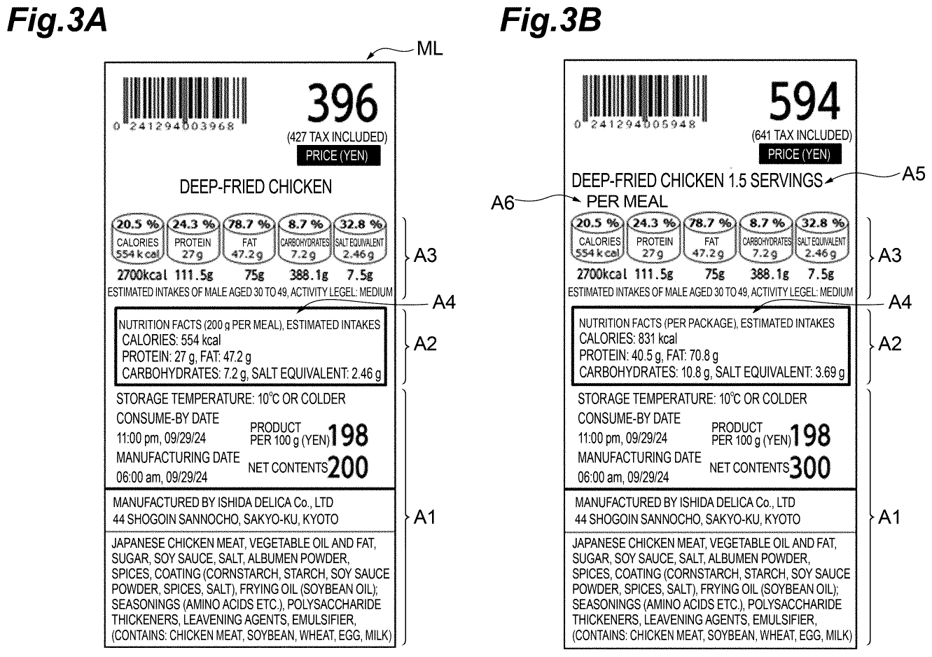

The label issuing apparatus 1 illustrated in FIG. 1 weighs a mass of a product and issues a product label ML (see FIGS. 3A and 3B) to be attached to the weighed product. As an example, a case where the label issuing apparatus 1 of the present embodiment is used in a self-service store in which a customer himself or herself weighs a mass of a product, issues a product label ML, and attaches the issued product label ML to the product, will be described. The label issuing apparatus 1 prints a plurality of pieces of product information regarding processed food on a label (print medium). As illustrated in FIGS. 1 and 2, the label issuing apparatus 1 includes a main body casing 3, an operation section 4, a display section 5, a weighing section 7, a printing section 9, a storage section 12, an acquisition section 14, and a controller 10.

The main body casing 3 is provided with the operation section 4, the display section 5, the printing section 9, and the controller 10. The main body casing 3 is formed in a substantially rectangular parallelepiped shape. An opening and closing door is provided on a front surface of the main body casing 3. When a state in which the opening and closing door is opened is reached, the printing section 9 disposed inside the main body casing 3 is exposed. The operation section 4 is provided on the main body casing 3. The operation section 4 is a section that accepts various operations from an operator. The operation section 4 includes a “unit price” key, a “fixed price” key, a “tare” key, “numeric” keys, a “print” key, a “call” key, and the like that are necessary as a pricing scale. The display section 5 displays various pieces of information, such as a state of the label issuing apparatus 1, an operation on the label issuing apparatus 1, and information regarding a product to be weighed. The display section 5 may be configured to include a touchscreen. In this case, similarly to the operation section 4, the display section 5 carries out a function of accepting various operations from the operator.

The weighing section 7 is configured as a separate body from the main body casing 3. The weighing section 7 mainly includes a weighing pan 7A, a load cell (not illustrated), a signal processing circuit, and a transmission module. The load cell is provided under the weighing pan 7A and supports the weighing pan 7A, and converts, into an electric signal, mechanical strain generated when an object to be weighed is placed on the weighing pan 7A, and outputs the electric signal. The signal processing circuit amplifies the electric signal output from the load cell and converts the amplified signal into a digital signal. The transmission module transmits the digital signal to the controller 10 in the main body casing 3 in a wireless or wired manner.

The printing section 9 is a printing device or a printer configured to print product information on a linerless label. The printing section 9 is housed in the main body casing 3 and includes a cassette, a printing unit, and a cutter unit that are not illustrated. The cassette detachably supports a label roll. The label roll is formed in a roll shape by winding the strip-shaped linerless label (hereinafter, simply referred to as a “label”) around a paper core. Note that in the present embodiment, in place of the linerless label, a label roll around which a label with a liner is wound may be used. The printing section 9 prints product information composed of a plurality of display items on the label and issues the label as the product label ML. In the present embodiment, the plurality of pieces of product information regarding processed food are printed on the label.

The printing unit includes a printhead and a platen roller. The printhead is configured with a thermal printhead. The printhead is controlled by the controller 10, which will be described in detail in later paragraphs. The platen roller presses the label from a back surface side of the label to press a front surface of the label against the printhead. The cutter unit cuts off the label fed from the printing unit as the product label ML having a predetermined length (see FIGS. 3A and 3B). That is, the cutter unit issues a portion printed by the printhead as the product label ML. Note that the printing method for the printing section 9 is illustrative, and various printing methods, such as a thermal transfer method and an inkjet method, can be employed.

The printing section 9 prints, on the label, the product information on the product to be weighed. This product information is stored in the storage section (first storage section and second storage section) 12 to be described later. More specifically, as illustrated in FIGS. 3A and 3B, the printing section 9 prints, on the label, the product information, such as net contents, a product unit price, a processing/manufacturing date, a consume-by date/best-before-date, processed/manufactured by, storage conditions, and ingredients (including contents of additives and allergies). In addition, the printing section 9 of the present embodiment prints information regarding nutrient amounts of the product to be weighed. Examples of the nutrient amounts include calories, protein, fat, carbohydrates, and salt equivalent. In other words, the printing section 9 prints what amount of each nutrient (calories, protein, fat, carbohydrates, salt equivalent, and the like) is included in the product to be weighed.

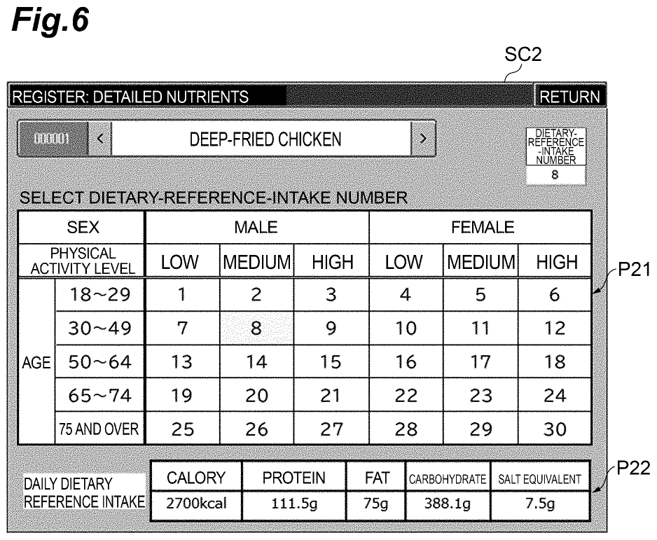

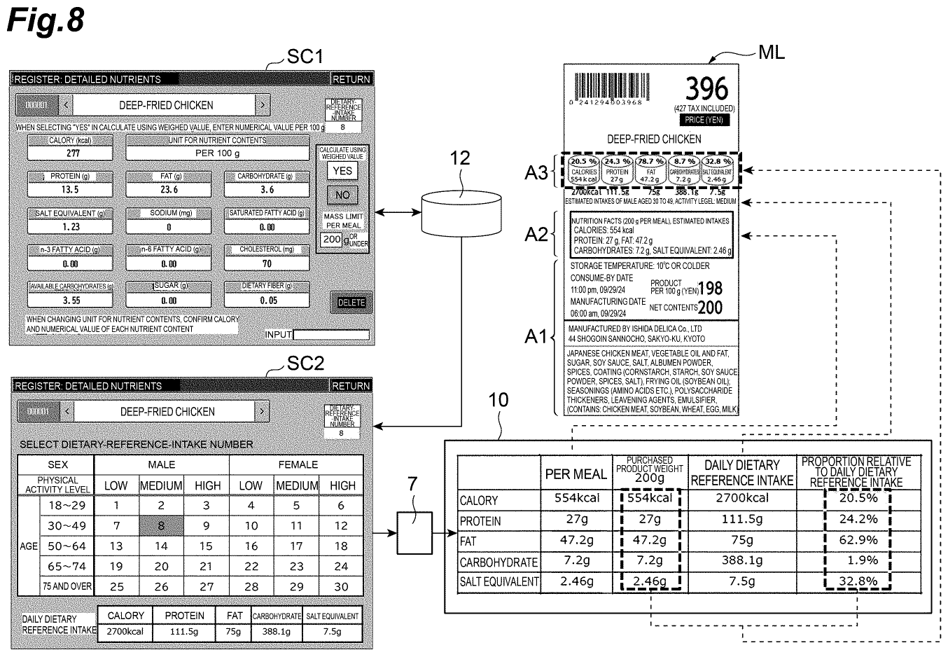

The printing section 9 of the present embodiment prints, on the label, information (hereinafter, abbreviated as “information regarding intake proportions”) regarding proportions of the amounts of nutrients included in the product relative to reference intakes. That is, the printing section 9 prints information regarding what amount of each nutrient is included in the product to be weighed relative to each reference intake. The reference intakes are, for example, nutrient amounts (in FIGS. 6 and 8, indicated as a daily dietary reference intakes) to be consumed per day. Further, the reference intakes used in the present embodiment are values designated for each category of physical characteristics (physical and demographic characteristics). That is, the printing section 9 of the present embodiment prints information regarding intake proportions according to physical characteristics of a purchaser of the product. The physical characteristics can be classified into categories, for example, by a combination of sex, age group, physical activity level, and the like. Different physical characteristics result in different reference intakes. The printing section 9 of the present embodiment prints information (for example, information regarding what percentages (%) of reference intakes to be consumed per day can be consumed) regarding intake proportions when the product to be weighed is eaten, according to the physical characteristics of the purchaser of the product.

As illustrated in FIGS. 3A and 3B, on the product label ML, the above product information is printed in an area A1, the above information regarding the nutrient amounts of the product is printed in an area A2, and the above information regarding the intake proportions is printed in an area A3. That is, the label issuing apparatus 1 of the present embodiment issues, as the product label ML, a label on which the above product information, the above information regarding the nutrient amounts of the product, and the above information regarding the intake proportions are printed.

In the present embodiment, as illustrated in FIG. 3A, the printing section 9 prints nutrient amounts per meal as the nutrient amounts of the product that are printed in the area A2 in the product label ML. An amount per meal here is an amount designated by a store operator or the like as an amount that a person usually consumes this food product at one time. When a weighing result of the product weighed by the weighing section 7 is equal to or less than a predetermined reference value, the printing section 9 prints the nutrient amounts per meal. For example, when the storage section 12 stores 200 g as the reference value of the amount per meal, the printing section 9 prints characters of “200 g per meal” to clearly indicate that a mass per meal is 200 g. Note that in the present embodiment, characters “per meal” are printed; however, representation using characters to be printed is not specified as long as the representation corresponds to a content, such as “per serving”, indicating an amount, a quantity, or the like per meal.

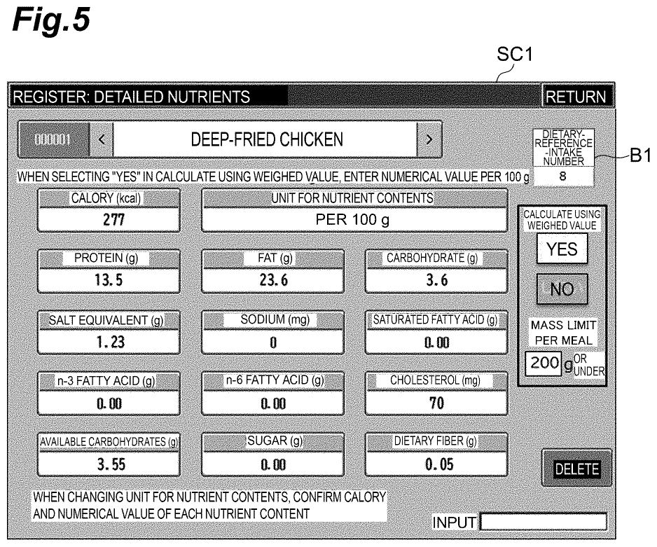

When the weighing result of the product weighed by the weighing section 7 exceeds the predetermined reference value, as illustrated in FIG. 3B, the printing section 9, instead of printing the nutrient amounts per meal, prints characters indicating “per package” or “per container”. The above reference value can be freely set in a reference value input section P11 of a nutrient amount registration screen SC1 as illustrated in FIG. 5, for example. Note that the nutrient amount registration screen SC1 illustrated in FIG. 5 will be described in detail in later paragraphs.

Returning to FIGS. 1 and 2, the storage section 12 stores various pieces of information. The storage section 12 stores various types of information. The storage section 12 is a storage device configured with, for example, a Solid State Drive (SSD), a Hard Disk Drive (HDD), or the like. The storage section 12 stores product information for each product. The product information is configured to include a plurality of contents as well as a call number and a product code of the product. Examples of the plurality of contents include a product name, the ingredients, the net contents, the processing/manufacturing date, the consume-by date/best-before-date, a storage temperature, processed/manufactured by, and the like, as illustrated in FIG. 3A.

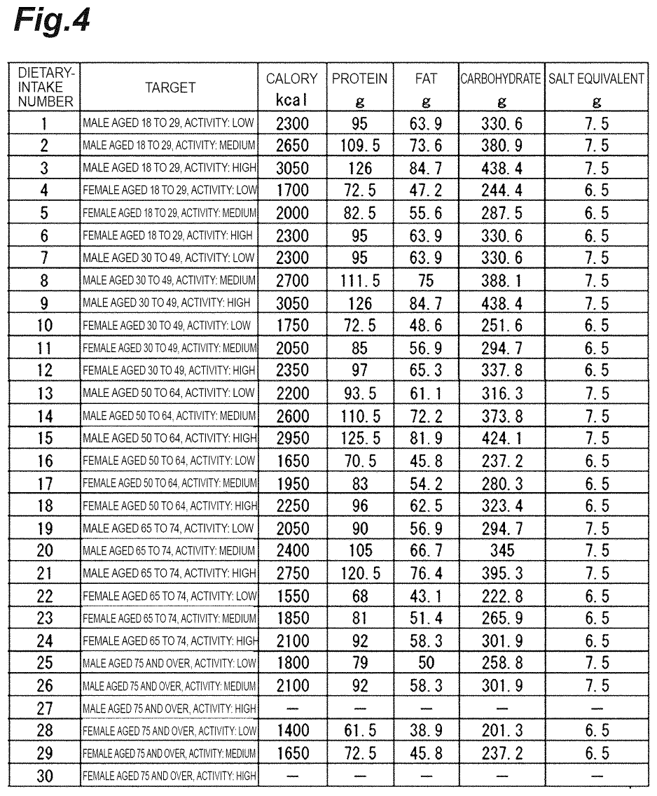

The storage section 12 stores nutrient amounts that adults (persons) are expected to consume per day, as the reference intakes. In addition, the storage section 12 of the present embodiment stores the reference intakes depending on differences in the physical characteristics of adults. The physical characteristics of adults can be classified into categories, for example, according to differences in ages, sexes, and physical activity levels of adults. In the present embodiment, as illustrated in FIG. 4, adults'ages are categorized into, for example, five groups aged 18 to 29, 30 to 49, 50 to 64, 65 to 74, and 75 and over. Sexes are categorized into two groups of male and female. Physical activity levels are categorized into three levels of low, medium, and high. The reference intakes are stored for 30 categories in which these age, sex, and physical activity level are combined. Examples of the nutrient amounts include the calories, the protein, the fat, the carbohydrates, and the salt equivalent. That is, the storage section 12 stores the reference intakes corresponding to calories, protein, fat, carbohydrates, and salt equivalent for each category of the physical characteristics that are classified into the 30 categories.

Note that the calories and a mass of protein in the reference intakes (hereinafter, also referred to as “reference intakes by physical characteristic”) for each category of the physical characteristics illustrated in FIG. 4 can be designated, for example, based on “estimated energy requirement” and “target amount of protein by physical activity level” described in “Dietary Reference Intakes for Japanese (2020)” of the Ministry of Health, Labour and Welfare. A mass of fat in the reference intakes by physical characteristic can be calculated based on the “Dietary Reference Intakes for Fat” described in the Dietary Reference Intakes for Japanese (2020). For example, since a target amount of fat is 20 to 30% of an intake energy (kcal), in a case of males aged 30 to 49, for example, the target amount is 2700 kcal×25%=675 kcal as illustrated in FIG. 4. Here, the fat is 9 kcal/g, so that the mass of the fat can be calculated as 675 kcal/9 kcal=75 g.

A mass of carbohydrates in the reference intakes by physical characteristic can be designated based on the “Dietary Reference Intakes for Carbohydrates” described in the Dietary Reference Intakes for Japanese (2020). For example, since a target amount of carbohydrates is 50 to 65% of the intake energy (kcal), in the case of males aged 30 to 49, for example, the target amount is 2700 kcal×57.5% (median of 50 to 65%)=1552.5 kcal as illustrated in FIG. 4. Here, the carbohydrates are 4 kcal/g, so that the mass of the carbohydrates can be calculated as 1552.5 kcal/4 kcal=388.1 g. The salt equivalent is a value obtained by converting an amount of sodium in a food product into an amount of salt, and when the amount of sodium (mg) is multiplied by 2.54 and divided by 1000, the salt equivalent (g) can be calculated. In the above-described 2020 edition of the Ministry of Health, Labour and Welfare, target values of the salt equivalent for adults per day are less than 7.5 g for males and less than 6.5 g for females.

The storage section 12 stores, for each product, nutrient amounts included in a product per unit mass (for example, per 100 g), a mass per meal of the product (for example, 200 g), and nutrient amounts when the product with the mass per meal is consumed. The nutrient amounts included in the product per unit mass, the mass per meal of the product, and the nutrient amounts when the product with the mass per meal is consumed that are stored in the storage section 12, are used when the controller 10 causes the printing section 9 to print the product label ML, as will be described in detail in later paragraphs.

Examples of the nutrient amounts described above include the calories (kcal), the protein (g), the fat (g), the carbohydrates (g), the salt equivalent (g), sodium (mg), saturated fatty acid (g), n-3 fatty acid (g), n-6 fatty acid (g), cholesterol (mg), available carbohydrates (mg), sugar (g), dietary fiber (g), and the like. Such nutrient amounts for each product can be stored in the storage section 12 by being input from the nutrient amount registration screen SC1 as illustrated in FIG. 5, for example. The nutrient amount registration screen SC1 illustrated in FIG. 5 is a registration screen for nutrient amounts per 100 g of a product “deep-fried chicken”. Similarly, the mass per meal (for example, 200 g) can also be calculated based on the nutrient amount registration screen SC1 illustrated in FIG. 5.

The acquisition section 14 acquires physical characteristics of the person who purchases the product. The acquisition section 14 acquires information regarding the physical characteristics from the storage section 12. The acquisition section 14 of the present embodiment is an interface, including an input interface or an input device, that enables communication between the controller 10 and the storage section 12. That is, the acquisition section 14 acquires, from the storage section 12, the information regarding the physical characteristics of the person who purchases the product. The acquisition section 14 outputs, to the controller 10, the acquired information regarding the physical characteristics of the person who purchases the product. To cause the storage section 12 to store the physical characteristics of the person who purchases the product (set in the label issuing apparatus 1), the storage can be executed from a physical-demographic characteristic setting screen SC2 as illustrated in FIG. 6, for example. The physical-demographic characteristic setting screen SC2 is displayed by operating a dietary-reference-intake number button B1 of the nutrient amount registration screen SC1 illustrated in FIG. 5.

As illustrated in FIG. 6, a physical-demographic characteristic selection section P21 is formed on the physical-demographic characteristic setting screen SC2. Each of numbers from 1 to 30 in the physical-demographic characteristic selection section P21 is configured to be selectable by the operator. Each of the numbers from 1 to 30 in the physical-demographic characteristic selection section P21 is colored when being brought into a selected state, and the selected state is recognizable. The numbers from 1 to 30 in the physical-demographic characteristic selection section P21 correspond to dietary-reference-intake numbers illustrated in FIG. 4. For example, when a dietary-reference-intake number “8” is selected in the physical-demographic characteristic setting screen SC2, physical characteristics of sex “male”, age “30 to 49”, and physical activity level “medium” are set via the reference intakes by physical characteristic (see FIG. 4) stored in the storage section 12. That is, it means that the storage section 12 stores the physical characteristics (dietary-reference-intake number: 8) of sex “male”, age “30 to 49”, and physical activity level “medium”.

The physical-demographic characteristic setting screen SC2 may display, on a reference intake display section P22 below the physical-demographic characteristic selection section P21, the reference intakes (daily dietary reference intakes) relevant to the physical characteristics selected in the physical-demographic characteristic selection section P21. Specifically, the reference intake display section P22 displays calories, protein, fat, carbohydrates, and salt equivalent as the reference intakes relevant to the physical characteristics selected in the physical-demographic characteristic selection section P21. Values displayed on the reference intake display section P22 can be acquired from the reference intakes by physical characteristic (see FIG. 4) stored in the storage section 12.

The physical characteristics (set in the label issuing apparatus 1) stored in advance in the storage section 12 can be set according to major customers of the store where the label issuing apparatus 1 is disposed. For example, in a case where customers who come to buy lunch boxes, daily dishes, or the like are office workers working in nearby companies, the dietary-reference-intake number “8” may be set assuming that physical characteristics of the customers are sex “male”, age “30 to 49”, and physical activity level “medium”.

Note here that the example is presented in which the physical characteristics are stored in advance in the storage section 12 based on the major customer segment employing a store; however, for example, when a configuration is such that a camera or the like is provided in the label issuing apparatus 1 and AI (Artificial Intelligence) or the like determines physical characteristics based on an image imaged by the camera or the like, the acquisition section 14 may acquire a determination result from the AI. A configuration may be such that, when a customer operates the label issuing apparatus 1, the physical-demographic characteristic setting screen SC2 as illustrated in FIG. 6 is displayed to cause the customer to input physical characteristics of a person who consumes the product. In this case, the acquisition section 14 acquires the physical characteristics (dietary-reference-intake number) selected in the physical-demographic characteristic setting screen SC2. In addition, the acquisition section 14 may acquire the physical characteristics of the customer from information or the like that is associated with a member card of the store, in which the physical characteristics of the customer are stored, owned by the customer. When the product is sold in a face-to-face manner, a salesperson may ask whether a person who consumes the product is himself or herself or a family member, and input approximate physical characteristics of that person.

The controller 10 is a section that controls various operations in the label issuing apparatus 1, and a CPU (Central Processing Unit), a ROM (Read Only Memory), a RAM (Random Access Memory) are connected to each other via a bus line, such as an address bus and a data bus. The controller 10 executes various pieces of control processing in the label issuing apparatus 1. The controller 10 can be configured as, for example, software in which programs stored in the ROM are loaded on the RAM and executed by the CPU. The controller 10 may be configured as hardware by an electronic circuit or the like.

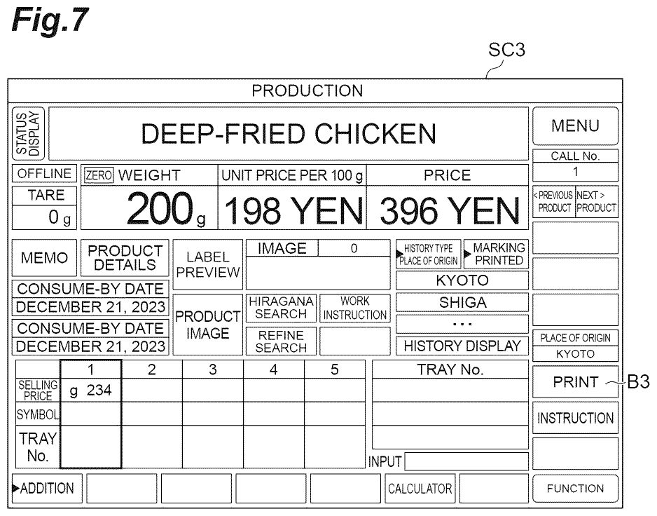

When the label issuing apparatus 1 issues the product label ML of the product to be weighed, the operator operates the operation section 4 to input or select a call number of the weighed product, or selects the weighed product from a product list screen displayed on the display section 5. At this time, the controller 10 acquires, from the storage section 12, product information relevant to the input or selected call number or the selected product, and controls to display a plurality of pieces of the acquired product information as a product information screen SC3 as illustrated in FIG. 7, for example. When the controller 10 detects that, in a state in which the product information screen SC3 is displayed on the display section 5, for example, the “print” key included in the operation section 4 is operated or that a print button B3 on the product information screen SC3 is operated, a product label ML of the product (“deep-fried chicken” in the example of FIG. 7) displayed on the product information screen SC3 is issued.

As illustrated in FIGS. 3A, 3B, and 8, when detecting that the “print” key is operated or that the print button B3 of the product information screen SC3 is operated, the controller 10 controls the printing section 9 such that the product information on the weighed product stored in the storage section 12 is printed in the area A1 of the product label ML.

In addition, the controller 10 calculates the nutrient amounts included in the weighed product based on the nutrient amounts per unit mass of the product (for example, per 100 g) and the mass of the product in an amount weighed by the weighing section 7. The controller 10 controls the printing section 9 to print the calculated nutrient amounts on the label as the nutrient amounts included in the weighed product. The controller 10 controls the printing section 9 such that the calculated nutrient amounts (calories, protein, fat, carbohydrates, and salt equivalent) of the weighed product are printed in the area A3 of the product label ML. In the present embodiment, values indicated in g (gram) in cylindrical figures in the area A3 of the product label ML are the calculated nutrient amounts. In a case of lunch boxes or the like, nutrient amounts calculated in advance depending on a weight of foodstuff to be served may be stored for each type of lunch box, and stored nutrient amounts may be acquired by specifying a type of lunch box and printed on the label.

As illustrated in FIG. 3A, the controller 10 acquires, from the storage section 12, the reference intakes relevant to the physical characteristics acquired via the acquisition section 14, and calculates proportions of the nutrient amounts included in the weighed product relative to the acquired reference intakes. That is, the controller 10 calculates what proportions of the reference intakes can be consumed when the weighed product is consumed. The controller 10 controls the printing section 9 so as to print the calculated proportions of the nutrient amounts on the label. The controller 10 controls the printing section 9 such that the calculated proportions (calories, protein, fat, carbohydrates, and salt equivalent) of the nutrient amounts of the weighed product are printed in the area A3 of the product label ML. In the present embodiment, the values displayed in % (percent) in the cylindrical figures of the area A3 in the product label ML are the proportions of the calculated nutrient amounts. In the case of lunch boxes or the like, reference intakes may be acquired from the storage section 12 based on a segment of customers who purchase the lunch boxes.

The controller 10 controls the printing section 9 so as to print, on the label, the reference intakes that serve as a basis for the calculation of the above proportions of the nutrient amounts. The controller 10 acquires, from the storage section 12, the reference intakes relevant to the physical characteristics acquired via the acquisition section 14, and controls the printing section 9 so as to print the acquired reference intakes in the area A3 of the product label ML. The reference intakes serving as the basis for the calculation of the above proportions of the nutrient amounts include the calories, the protein, the fat, the carbohydrates, and the salt equivalent. In the present embodiment, the respective values of the calories, the protein, the fat, the carbohydrates, and the salt equivalent that are displayed beneath the cylindrical figures in the area A3 of the product label ML correspond to the reference intakes relevant to the physical characteristics. Note that, in the area A3, it is clearly indicated for which physical and demographic characteristics the reference intakes are, such as “male aged 30 to 49, activity level: medium”.

The controller 10 controls the printing section 9 so as to print, on the label, the mass per meal of the weighed product and the nutrient amounts when the product with the mass per meal is consumed, and to print the mass per meal of the weighed product on the area A2 of the label following characters A4 indicating “per meal”. The controller 10 acquires, from the storage section 12, the mass per meal of the weighed product and the nutrient amounts when the weighed product with the mass per meal is consumed, and controls the printing section 9 so as to print, in the area A2 of the product label ML, the acquired mass per meal and nutrient amounts when the weighed product with the mass per meal is consumed. The nutrient amounts when the weighed product with the mass per meal is consumed include the calories, the protein, the fat, the carbohydrates, and the salt equivalent.

As illustrated in FIG. 3B, when a mass of a weighed product exceeds the mass per meal of the product stored in the storage section 12, the controller 10 controls the printing section 9 so as to print characters A4 “per package” in the area A2 of the label. In addition, the controller 10 controls the printing section 9 so as to print, in an area A5 of the label, a value including a decimal part indicating how many meals (for how many persons) the weighed product provides, the value being obtained by dividing the mass of the weighed product in an amount weighed by the weighing section 7 by the mass per meal of the product. In addition, the controller 10 controls the printing section 9 so as to print an indication “per meal” in an area A6 below an area in which the product name is printed in the area A5 of the product label ML.

Workings and effects of the label issuing apparatus 1 of the above embodiment will be described. In the label issuing apparatus 1 of the above embodiment, it is possible to provide the purchaser with what percentages (%) of the nutrient amounts the purchaser is supposed to consume (proportions of the nutrient amounts) by consuming the weighed product (purchased food), for example, relative to the reference intakes that are the nutrient amounts to be consumed per day. Furthermore, in the label issuing apparatus 1 of the above embodiment, it is possible to provide the above proportions of the nutrient amounts depending on physical attributes (for example, male aged 30 to 49, physical activity level: medium) of the purchaser as illustrated in FIG. 3A, instead of simply providing proportions of nutrient amounts with respect to adult models in a generalized manner. This makes it possible to respond to a further increased disclosure demand from consumers.

The label issuing apparatus 1 of the above embodiment issues the product label ML as illustrated in FIGS. 3A and 3B on which, in addition to the product information on the weighed product, the nutrient amounts included in the weighed product (see the area A3), the proportions of the nutrient amounts included in the weighed product relative to the reference intakes (daily dietary reference intakes) relevant to the physical characteristics (see the area A3), the nutrient amounts per meal (for example, 200 g) (see the area A2), and the reference intakes used for calculating the proportions of the nutrient amounts (see the area A3), are printed. This allows information tailored to the physical characteristics of the purchaser to be provided, so that it is possible to respond more to the further increased disclosure demand from purchasers.

In the label issuing apparatus 1 of the above embodiment, the physical characteristics are classified into the categories according to the differences in ages, sexes, and physical activity levels of adults, and the storage section 12 stores, for each category of the classified physical characteristics, each of the masses of the protein, the fat, the carbohydrates, and the salt equivalent and the calories that are required as the nutrient amounts to be consumed per day for each category of the classified physical characteristics. This makes it possible to easily categorize the physical and demographic characteristics of the purchaser, and moreover, it is possible to provide proportions of calories, protein, fat, carbohydrates, and salt equivalent relative to the reference intakes, which are different for each product and for each category of physical and demographic characteristics of purchasers.

In the case where the mass of the weighed product exceeds the mass per meal of the product stored in the storage section 12, the controller 10 of the label issuing apparatus 1 of the above embodiment controls the printing section 9 so as to print, on the label as illustrated in FIG. 3B, the characters A4 “per package”, and the value including a decimal part indicating how many meals the weighed product provides, the value being obtained by dividing the mass of the weighed product by the mass per meal of the product (see the area A2 in FIG. 3B). This makes it possible to, if the mass of the weighed product exceeds the mass per meal of the product, flexibly switch whether to print the characters “per package” on the label or print the value indicating how many meals the weighed product provides.

The controller 10 of the label issuing apparatus 1 of the above embodiment controls the printing section 9 so as to print, on the label as illustrated in FIG. 3A, in addition to the calculated proportions of the nutrient amounts, the reference intakes relevant to the physical characteristics acquired via the acquisition section 14 (see the area A3 in FIG. 3A). This makes it possible to provide the purchaser with the reference intakes that are the nutrient amounts for the purchaser to consume per day.

While the embodiment is described above, the aspect of the present invention is not limited to the above embodiment. Various modifications can be made without departing from the gist of the invention.

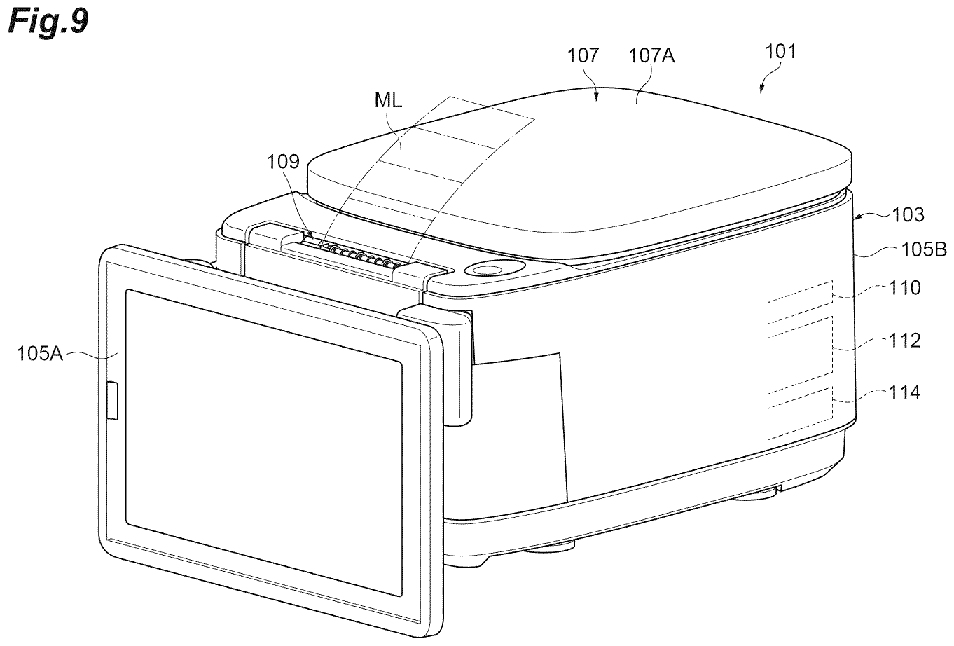

In the above embodiment, as an example, the case where the product handling apparatus is used in the self-service store in which the customer himself or herself weighs the mass of the product, issues the product label ML, and attaches the issued product label ML to the product, is described; however, the present invention is also applicable to a product handling apparatus used in a store with face-to-face sales in which a salesperson weighs a mass of a product, issues a product label ML, and attaches the issued product label ML to the product. As illustrated in FIG. 9, an example of such a product handling apparatus is a face-to-face scale apparatus (product handling apparatus) 101 including a salesperson-side operation section 105A and a customer-side operation section 105B. The face-to-face scale apparatus 101 includes a main body casing 103, the salesperson-side operation section 105A and the customer-side operation section 105B that are configured with touchscreens, a weighing section 107 having a weighing pan 107A, a printing section 109 that issues a product label ML, a controller 110, a storage section 112, and an acquisition section 114.

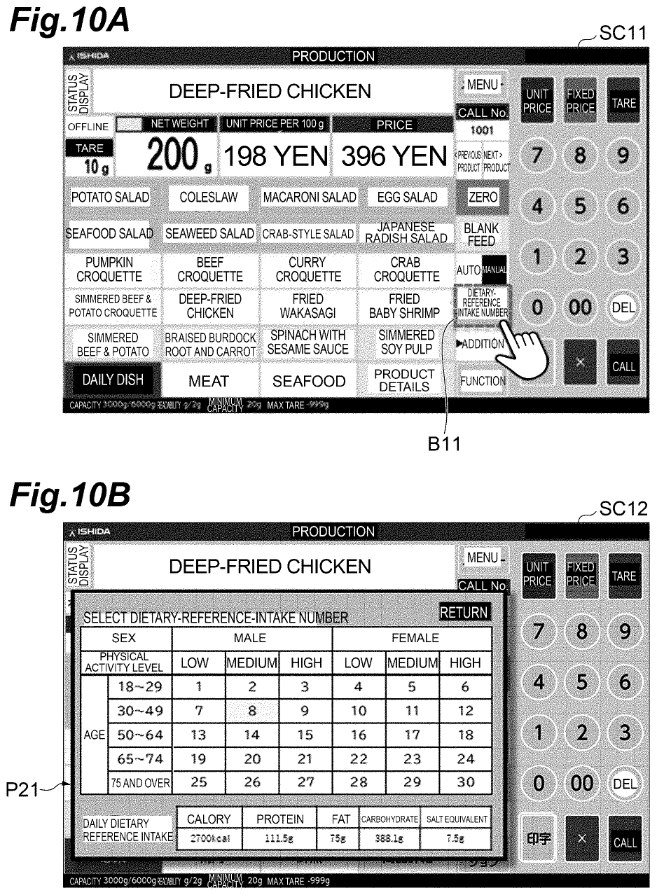

In the face-to-face scale apparatus 101 with such a configuration, while a product selection screen SC11 as illustrated in FIG. 10A is displayed on the salesperson-side operation section 105A, a salesperson selects a product and weighs the product. At this time, the salesperson causes a physical-demographic characteristic setting screen SC12 as illustrated in FIG. 10B to be displayed by operating a dietary-reference-intake number button B11 on the product selection screen SC11. The salesperson determines physical characteristics of a customer, and selects a number pertinent to the determined physical characteristics from 1 to 30. For example, when the salesperson determines that a purchaser of a weighed product is sex “male”, age “30 to 49”, and physical activity level “medium”, the salesperson may perform an operation of selecting “dietary-reference-intake number: 8” in a physical-demographic characteristic selection section P21.

The dietary-reference-intake number: 8 selected by the salesperson in the physical-demographic characteristic setting screen SC12 is stored in the storage section 112. That is, the acquisition section 114 acquires, from the storage section 112, information (i.e., dietary-reference-intake number: 8) regarding the physical characteristics of the person who purchases the product. The acquisition section 114 outputs, to the controller 110, the acquired information regarding the physical characteristics of the person who purchases the product. The controller 110 acquires, from the storage section 112, reference intakes relevant to the physical characteristics acquired via the acquisition section 114, and calculates proportions of nutrient amounts included in the weighed product relative to the acquired reference intakes. Subsequent control on the printing section 109 in the controller 110 is the same as that in the above embodiment, so that the detailed description thereof will be omitted. That is, the controller 110 controls the printing section 109 to print the product label ML as illustrated in FIG. 3A or 3B.

The face-to-face scale apparatus 101 with such a configuration can also accomplish the same workings and effects as those of the label issuing apparatus 1 of the above embodiment.

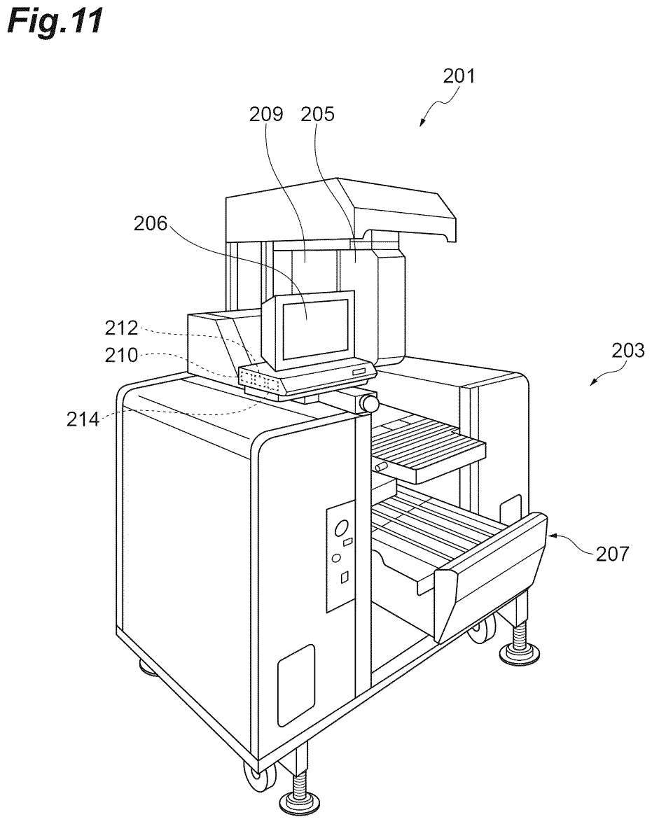

In the above embodiment and the above modification, as the examples of the product handling apparatus, the label issuing apparatus 1 as illustrated in FIG. 1 and the face-to-face scale apparatus 101 as illustrated in FIG. 9 are described as examples; however, for example, the present invention may be applied to a weighing-packaging-labeling apparatus (product handling apparatus) 201, as illustrated in FIG. 11, that after packaging a product, issues a product label ML on which product information regarding the product is printed, and attaches the product label ML to the product. The weighing-packaging-labeling apparatus 201 includes a weighing section 207, a packaging section 203, a printing section 209, an attaching section 205, a display operation section 206 configured with a touchscreen, a controller 210, a storage section 212, and an acquisition section 214.

The weighing-packaging-labeling apparatus 201 with such a configuration can also accomplish the same workings and effects as those of the label issuing apparatus 1 of the above embodiment and the face-to-face scale apparatus 101 of the above modification.

In the above embodiment and the above modifications, the example in which the calories, the protein, the fat, the carbohydrates, and the salt equivalent are taken as examples of the reference intakes, is described; however, other items may be adopted instead of or in addition to these items. In addition, the above embodiment and the above modifications are described as an example in which one category is selected, from the categories of the physical characteristics composed of the 30 categories, according to the differences in ages, sexes, and physical activity levels of adults; however, for example, the categories may each be composed of at least one of the age, the sex, and the physical activity level of adults, or the categories of the age classes and the physical activity levels may be different from the table illustrated in FIG. 4. Furthermore, the categories of the physical and demographic characteristics can be freely set, for example, to distinguish between adults and children, not just among adults.

The example is described in which the storage section that stores the nutrient amounts for adults to consume per day as the reference intakes depending on the differences in the physical characteristics of adult, and the storage section that stores, for each product, the mass per meal of the product and the nutrient amounts when the product with the mass per meal is consumed are the same storage section 12; however, these storage sections may be different from each other, or may be storage apparatuses, such as the cloud.

What is claimed is:

1. A product handling apparatus configured to calculate nutrient amounts of a product based on nutrient amounts per unit mass of the product and a mass of the product in a weighed amount, and print, on a print medium, the calculated nutrient amounts as nutrient amounts of the product, the product handling apparatus comprising:
a first storage section configured to store nutrient amounts for a person to consume per day as reference intakes in accordance with differences in physical characteristics of the person;
an acquisition section configured to acquire the physical characteristics of the person who purchases the product; and
a controller configured to acquire, from the first storage section, the reference intakes corresponding to the physical characteristics acquired by the acquisition section, calculate proportions of the nutrient amounts included in the product relative to the acquired reference intakes, and control a printing section to print the calculated proportions of the nutrient amounts on the print medium.

2. The product handling apparatus according to claim 1, wherein
the physical characteristics are classified according to differences in age, sex and physical activity level of people, and
the first storage section stores, for each of the classified physical characteristics, calories as well as masses for each of protein, fat, carbohydrates and salt equivalent that are required as the nutrient amounts to be consumed per day.

3. The product handling apparatus according to claim 1, wherein the controller controls the printing section to print, in addition to the calculated proportions of the nutrient amounts, the reference intakes serving as a basis for the calculation of the proportions of the nutrient amounts on the print medium as estimated values.

4. The product handling apparatus according to claim 1, comprising
a second storage section configured to store, for each product, a mass per meal of the product and nutrient amounts when the product with the mass per meal is consumed, wherein
the controller
controls the printing section to print on the print medium, in addition to the calculated proportions of the nutrient amounts, a mass per meal of the product in a weighed amount and nutrient amounts when the product in a weighed amount with the mass per meal is consumed, and
controls the printing section to print the mass per meal of the product in a weighed amount on the print medium following characters indicating a content of “per meal”.

5. The product handling apparatus according to claim 4, wherein, when the mass of the product in a weighed amount exceeds the mass per meal of the product stored in the second storage section, the controller controls the printing section to print characters of “per package” on the print medium, or to print, on the print medium, a value including a decimal part indicating how many meals the product in a weighed amount provides, the value being obtained by dividing the mass of the product in a weighed amount by the mass per meal of the product.

6. The product handling apparatus according to claim 1, wherein the controller controls the printing section to print on the print medium, in addition to the calculated proportions of the nutrient amounts, the reference intakes relevant to the physical characteristics acquired by the acquisition section.
